(19) United States
(12) Patent Application Publication
(10) Pub. No.: US 2012/0119567 A1
(43) Pub. Date: May 17, 2012

(54) Cartridge Seal for Track Chain Bushing

(75) Inventors: Eric Johannsen, Washington, IL (US); Roger Recker, Dunlap, IL (US)

(73) Assignee: Caterpillar, Inc., Peoria, IL (US)

(21) Appl. No.: 12/947,422

(22) Filed: Nov. 16, 2010

(51) Int. Cl. B62D 55/08; B62D 55/32; B62D 55/088

(52) U.S. Cl. 305/103; 16/2.2; 305/202

(57) ABSTRACT

A cartridge for a track chain used to propel a track machine is disclosed. The cartridge includes a pin that passes axially through a bushing. The bushing may include two opposing ends and a cylindrical outer surface extending between the opposing ends of the bushing. Each end of the bushing includes an annular seal pocket for accommodating a seal and an annular step groove for coupling each end of the bushing to an inner track link. The bushing may be axially disposed between two inserts and the seals are track seals that engage one of the inserts. The inserts may be axially disposed between two collars and the collars are coupled to the pin. The collars may also include annular seal pockets that accommodate track seals.

### TECHNICAL FIELD

This disclosure relates generally to chain for a track work machine and, more particularly, to a cartridge assembly for coupling links disposed on opposite sides of the chain together.

### BACKGROUND

Track work machines utilize articulating track chains for propelling the work machines over the terrain during operation. Such track chains operate in extremely adverse environments in which track joints may be exposed to various abrasive mixtures of water, dirt, sand, rock and/or chemical elements and to wide temperature ranges varying from high heat in deserts and extreme cold in arctic regions. Consequently, seals are placed in the track joints and must be maintained to ensure that the seal will effectively exclude contaminants and retain lubricant during use.

Typical track chain designs include a track pin either rotatably or fixed to a pair of chain links or two pairs of chain links and have a bushing rotatably positioned between the links and about the track pin. These designs have included a variety of seal configurations and positions such as against an inside face of the link or against the track bushing. Some typical cartridge assemblies include a bushing with a pair of bearing members positioned adjacent each end face of the bushing. The bearing members and the bushing are retained by a pair of collars that are press fit or welded to the ends of the track pin. Seal grooves are positioned in each end of the bearing members and the collars in which a seal arrangement may be placed. The seal arrangements push against the end faces of the bushing and the end faces of the bearings. However, despite the use of two seals at either end of the bushing, keeping the seal areas free from contaminants and the positioning of the seals remains problematic. Therefore, improved designs are needed.

### SUMMARY OF THE DISCLOSURE

In one aspect, a cartridge for a track chain for a track undercarriage is disclosed. The cartridge includes a bushing including two opposing ends. Each end of the bushing includes an annular seal pocket. Each pocket accommodates a seal.

In another aspect, a cartridge for a track chain is disclosed. The cartridge includes a pin that passes axially through a bushing. The bushing includes two opposing ends and a cylindrical outer surface extending between the two opposing ends. Each end of the bushing may include an annular seal pocket for accommodating a seal and an annular step groove for coupling each end of the bushing to an inner track link. The bushing may be axially disposed between two inserts and the seals are track seals that each engages one of the inserts. The inserts are axially disposed between two collars. The collars may be coupled to the pin. The collars may each include annular seal pockets. By moving the seal pockets from the inserts or bearings to the bushing, wider inserts may be employed for improved insert retention.

In yet another aspect, a method of replacing an existing cartridge of an existing link subassembly of a track chain is disclosed. The method includes detaching ends of the track chain at a master link. The method further includes removing the existing cartridge from the existing link subassembly that includes two pairs of inner and outer links. The method further includes providing a new cartridge for the link subassembly. The new cartridge includes a pin that passes axially through a bushing. The bushing includes two opposing ends and a cylindrical outer surface extending between the two ends. Each end of the bushing may include an annular seal pocket for accommodating seals and an annular step groove for coupling each end of the bushing to an inner track link. The bushing may be axially disposed between two inserts and the seals are track seals that each engages one of the inserts. The method also includes press fitting the cartridge between the two pairs of inner and outer track links.

In any one or more of the aspects described above, the bushing may include annular step grooves for coupling each end of the bushing to an inner track link. In any one or more of the aspects described above, the bushing may be disposed between two inserts or bearings. In combination with any one or more of the aspects described above, the seals disposed at the ends of the bushings may be track seals that each may engage one of the inserts. In any one or more of the aspects described above, each insert may be disposed between a collar and a bushing and the two collars may be coupled to the pin that extends axially through the bushing. The collars may each include annular seal pockets. In combination with any one or more of the aspects described above, a thrust ring may be disposed between each annular seal pocket of each collar and the pin. In combination with any one or more of the aspects described above, each collar may be disposed between the pin and an outer link. In combination with any one or more of the aspects described above, each insert or bearing may be disposed between the pin and an inner link.

### BRIEF DESCRIPTION OF THE DRAWINGS

FIG. 1 is a section view of a disclosed cartridge assembly for a track chain assembly;

FIGS. 2 and 3 illustrate the placement of the bushing end closer to the inner link to provide an improved seal labyrinth;

FIG. 4 illustrates the disclosed cartridge passing over an idler; and

FIG. 5 illustrates a disclosed cartridge passing over a sprocket.

### DETAILED DESCRIPTION

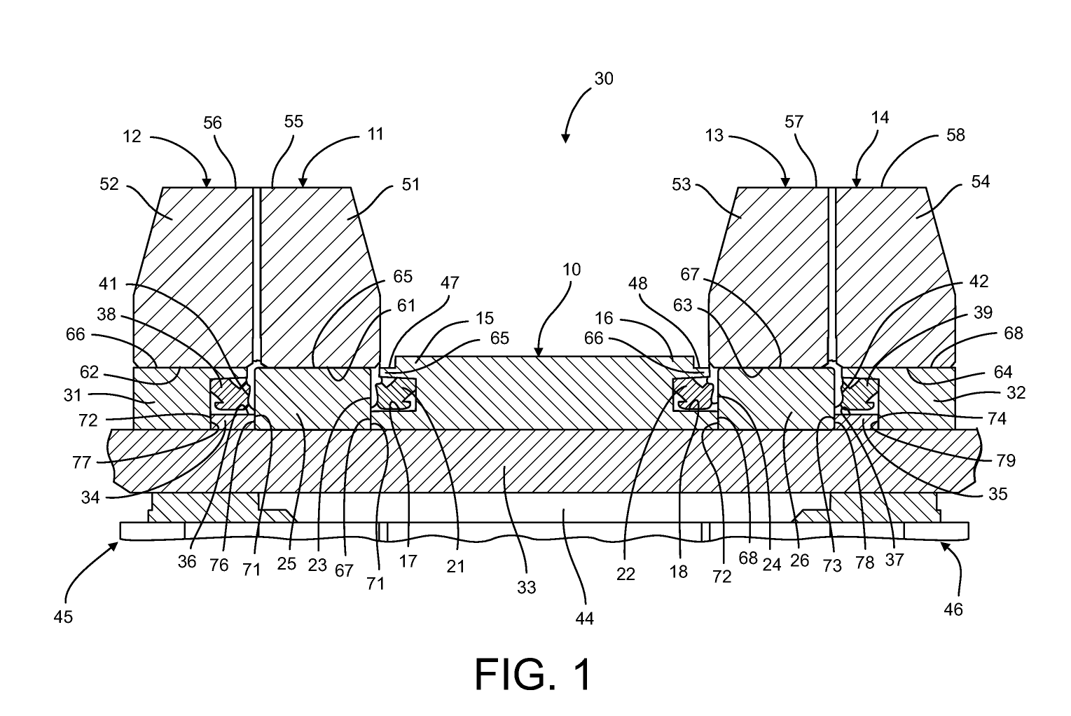

FIG. 1 illustrates a sectional view of a disclosed bushing 10 disposed between and extending through two pairs of inner and outer links 11, 12 and 13, 14 respectively. The bushing 10 may include two opposing ends 15, 16. Each opposing end 15, 16 may include an annular seal pocket 17, 18 respectively. Each annular seal pocket 17, 18 may include a seal 21, 22 respectively which, in the embodiment illustrated, may be a track seal. Each seal 21, 22 may include an additional layer 23, 24 of wear resistant material for engaging the inserts or bearings 25, 26.

The assembly 30 illustrated in FIG. 1 may also include collars 31, 32 that are coupled to the pin 33 that passes axially through the bushing 10. The collars 31, 32 may be permanently fixed to the pin 33 by welding, a secure press-fit or a detachable connection means such as a threaded connection or a connection involving pins or other fasteners.

Thrust rings 34, 35 may be disposed between the collars 31, 32 and inserts 25, 26. Additional annular seal pockets 36, 37 may be formed by the collars 31, 32, the thrust rings 34, 35 and the inserts 25, 26. As will be apparent to those skilled in the art, the annular seal pockets 36, 37 could be formed entirely by the collars 31, 32 or they could be formed entirely by the bearings or inserts 25, 26. Other designs will also be apparent to those skilled in the art. The annular seal pockets 36, 37 also accommodate seals 38, 39 which, in the embodiments illustrated, may be track seals. Of course, other types of seals will be apparent to those skilled in the art. Additional wear resistant layers or tips 41, 42 may be provided on the seals 38, 39 for engaging the inserts 25, 26 respectively. The interior 44 of the pin 33 may be sealed with plug assemblies shown generally at 45, 46.

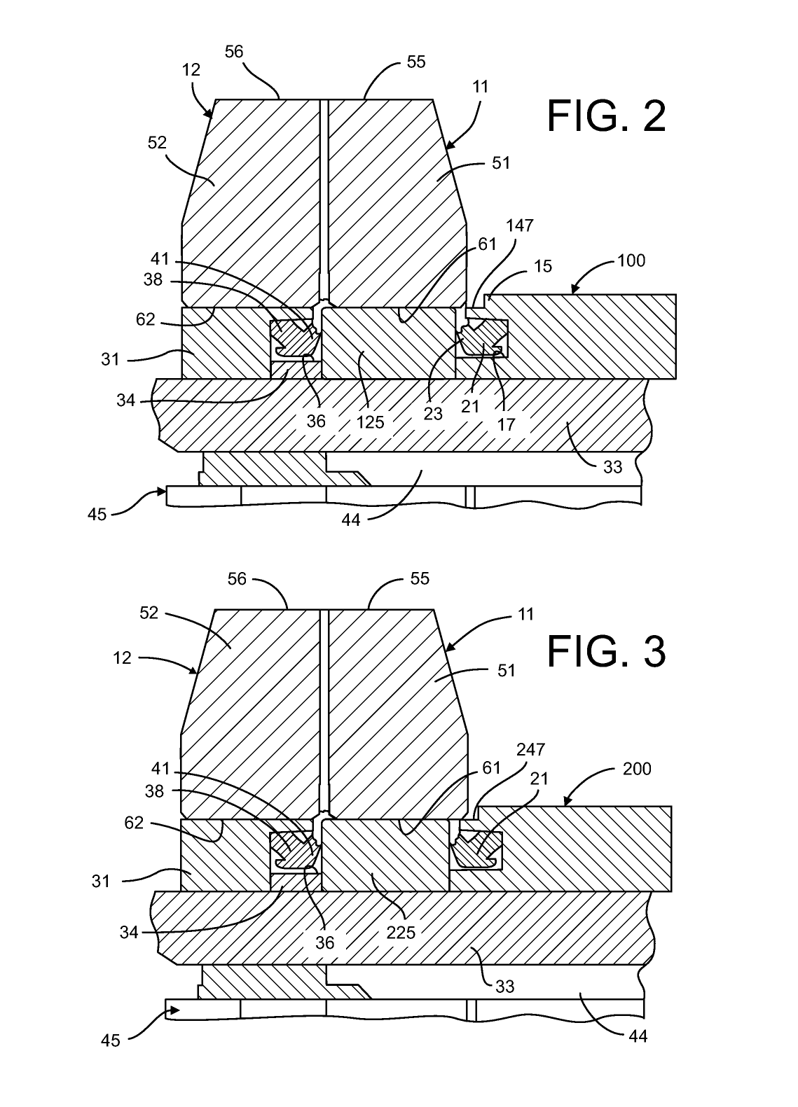

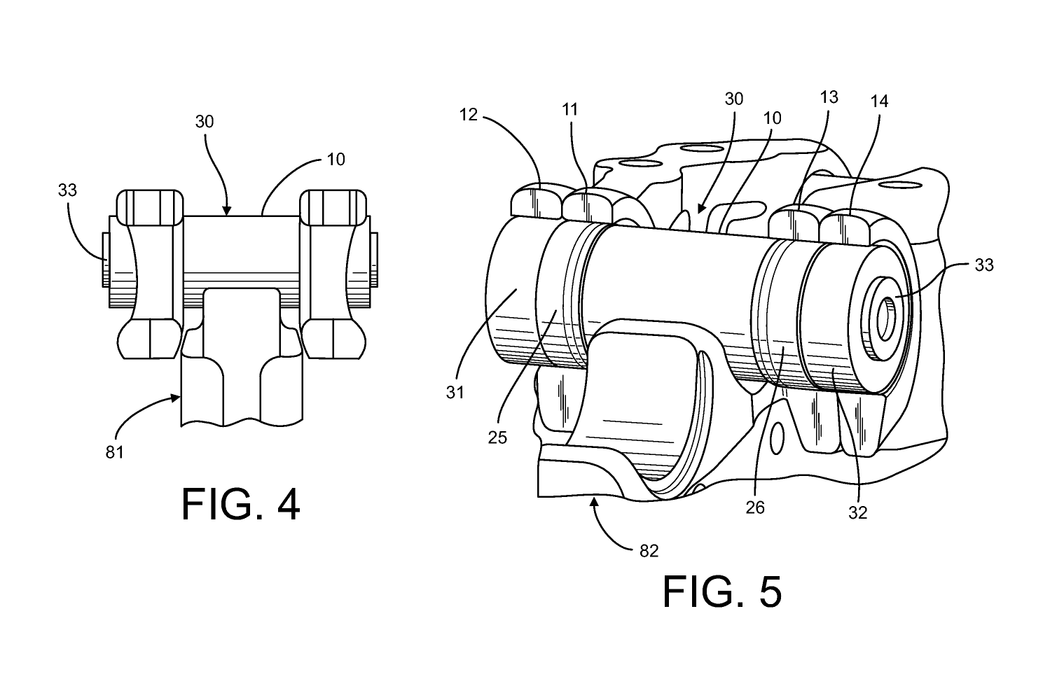

Thus, the outer links 12, 14 ride on the collars 31, 32 which are secured to the pin 33. The inner links 11, 13 ride on the inserts 25, 26 (or bearings 25, 26). The bushing 10 may be coupled to the inner links 11, 13 by the annular step grooves 47, 48. As illustrated in FIGS. 2-3, the size of the annular step grooves 47, 48 may vary. In FIG. 2, the annular step groove 147 is smaller than the annular step groove 247 illustrated in FIG. 3. The step grooves 47, 48, 147, 247 may help to protect the seals 21, 22 from the idler and sprocket loads and also provide additional strength for the bushings 10, 100, 200. Also shown in FIGS. 2-3 are variations in the geometries of the inserts 125, 225. The wider insert 125 helps to retain the inner link 11 in place so it does not interfere with the sprocket or idler which are discussed below in connection with FIGS. 4-5.

Still referring to FIGS. 1-3, it should be appreciated that the collars 31, 32 and inserts 25, 26 are substantially identical. Variations in the sizes of the inserts 125, 225 and the annular step grooves 147, 247 are illustrated in FIGS. 2-3. The design of the overall cartridge or assembly 30 need not be symmetrical. Further, the thrust rings 34, 35 may be integral to the collars 31, 32 or inserts 25, 26, 125, 225.

The inner and outer links 11, 12, 13, 14 may include main body portions 51, 52, 53, 54 as well as shoe abutment surfaces 55, 56, 57, 58. Each link 11, 12, 13, 14 may also include a rail surface 61, 62, 63, 64.

The cartridge assembly 30 illustrated in FIG. 1 and variations thereof illustrated in FIGS. 2-3 provide a suitable labyrinth to prevent dirt and contaminates from entering the annular seal pockets 17, 18, 36, 37. Specifically, (1) the annular steps 65, 66 of the bushing 10 that extend beneath the inner links 11, 13 in combination with (2) the abutting engagement between the upper surfaces 65, 67, 66, 68 of the inserts 25, 26 and collars 31, 32 respectively and the rail surfaces 61, 62, 63, 64 of the links 11, 12, 13, 14 in addition to (3) the engagement between the upper annular surfaces 67, 68 of the bushing 10 and the inner surfaces 71, 72 of the inserts 25, 26 may be combined to provide a suitable labyrinth-like structure to limit contamination of the annular seal pockets 17, 18. Similarly, (1) the engagement between the rail surfaces 62, 64 of the outer links 12, 14 and the upper surfaces 66, 68 of the collars 31, 32, in combination with (2) the engagement between the inner surfaces 71, 72, 73, 74 of the thrust rings 34, 35 and the end surfaces 76, 77, 78, 79 of the insert 25, collar 31, insert 26, and collar 32 may also be combined to provide a labyrinth-type structure to limit contamination of the annular seal pockets 36, 37.

The thickness of the bushing 10 has been increased over prior art bushings to provide for thicker inserts 25, 26, 125, 225 for improved insert retention. Also contributing to insert retention is the placement of the seal pockets 17, 18 in the bushing 10 as opposed to the inserts 25, 26.

An engagement between the cartridge assembly 30 and an idler 81 is illustrated in FIG. 4 and an engagement between the cartridge assembly 30 and a sprocket 82 is illustrated in FIG. 5.

### INDUSTRIAL APPLICABILITY

Cartridge assemblies for track chains of track undercarriages are shown and described. The disclosed design provides stronger bushings, improved insert (bearing) retention, wider inserts and improved annular seal designs which reduce dirt and contamination and therefore premature wear of the seals. A bushing design is also disclosed with annular seal pockets disposed at each end of the bushing. The improved bushing design also includes annular step grooves or annular steps for coupling each end of the bushing to the inner track link. The geometry of the inserts or bearings disposed at either end of the bushing may be varied to improve insert retention. Thrust rings may be included between the outer collars and the inner inserts or thrust rings may be formed from the collars and/or inserts themselves. A second or outer annular seal pocket may be formed by the insert, collar and thrust ring.

To replace existing prior art cartridges with the disclosed cartridges, the chain may be detached at the master link prior to removal of an existing cartridge in need of replacement. The new cartridge, which includes a pin passing axially through an improved bushing with outer annular seal pockets, two insert and two collars may be press fitted through the inner and outer links.

What is claimed is:

1. A cartridge for a track chain, comprising:
a bushing including two opposing ends;
each end of the bushing including an annular seal pocket for accommodating seal.

2. The cartridge of claim 1 wherein the bushing further includes annular step grooves for coupling each end to an inner track link.

3. The cartridge of claim 1 wherein the bushing is disposed between two inserts.

4. The cartridge of claim 3 wherein the seals are track seals that each engage one of the inserts.

5. The cartridge of claim 1 wherein the inserts are disposed between two collars, the collars are coupled to a pin that extends axially through the bushing, the collars each including annular seal pockets.

6. The cartridge of claim 5 further including a thrust ring disposed between each annular seal pocket of each collar and the pin.

7. The cartridge of claim 5 wherein each collar is disposed between the pin and an outer link.

8. The cartridge of claim 3 and each insert is disposed between the pin and an inner link.

9. A cartridge for a track chain, comprising:
a pin, the pin passing axially through a bushing;
the bushing including two opposing ends, a cylindrical outer surface extending between the ends of the bushing; each end of the bushing including an annular seal pocket for accommodating a seal and an annular step groove for coupling each end to an inner track link;
the bushing is axially disposed between two inserts and the seals are track seals that each engages one of the inserts;
the inserts are axially disposed between two collars, the collars are coupled to the pin, the collars each including annular seal pockets.

10. The cartridge of claim 9 further including a thrust ring radially disposed between the annular seal pocket of the collar and the pin.

11. The cartridge of claim 9 wherein each collar is radially disposed between the pin and an outer link.

12. The cartridge of claim 9 and each insert is radially disposed between the pin and an inner link.

13. A method of replacing an existing cartridge of an existing link subassembly of a track chain, the method comprising:
detaching ends of the track chain at a master link;
removing the existing cartridge from the existing link subassembly, the existing link subassembly including two pairs of inner and outer links;
providing a new cartridge for the link subassembly, the new cartridge including a pin, the pin passing axially through a bushing, the bushing including two opposing ends, a cylindrical outer surface extending between the ends of the bushing; each end of the bushing including annular seal pockets at for accommodating seals and an annular step groove for coupling each end of the bushing to an inner track link; the bushing is axially disposed between two inserts and the seals are track seals that each engage one of the inserts;
press fitting the cartridge through the two pairs of inner and outer links.

14. The method of claim 13 wherein the inserts are axially disposed between two collars, the collars are coupled to a pin that extends axially through the bushing, the collars each including annular seal pockets.

15. The method of claim 14 further including a thrust ring radially disposed between the annular seal pocket of the collar and the pin.

16. The method of claim 14 wherein each collar is radially disposed between the pin and one of the outer links.

17. The cartridge of claim 13 and each insert is radially disposed between the pin and one of the inner links.

18. A bushing comprising:
two opposing ends and a cylindrical outer surface disposed therebetween;
each end of the bushing including an annular seal pocket for accommodating seals.

19. The bushing of claim 18 wherein the bushing further includes annular step grooves for coupling each end to an inner track link.

20. The bushing of claim 18 wherein the seals are track seals.
